(19) United States
(12) Patent Application Publication
(10) Pub. No.: US 2018/0305648 A1
(43) Pub. Date: Oct. 25, 2018

(54) Systems and methods for distilling food grade ethanol from food waste

(71) Applicant: CMA Engineers, Inc., Portland, ME (US)

(72) Inventor: Robert J. Grillo, Portland, ME (US)

(21) Appl. No.: 15/492,621

(22) Filed: Apr. 20, 2017

(51) Int. Cl. C12G 3/02; C12G 3/12; B01D 3/00

(52) U.S. Cl. CPC C12G 3/02; B01D 3/004; C12G 3/12

(57) ABSTRACT

A system and method for producing food-grade ethanol from food waste. A method of producing ethanol or vodka from food waste includes the steps of selecting one or more sources of food waste, where each source is a restaurant, a bakery, a grocery store, a commercial kitchen, a food vendor, or a commercial food products manufacturer; receiving collected food waste from the source(s); removing unacceptable items from the collected food waste; and processing the hydrated food waste into a flowable slurry ready for fermentation and then distillation.

### BACKGROUND OF THE INVENTION

### 1. Field of the Invention

The present invention relates generally to methods for producing ethanol. More particularly, the present invention relates to systems and methods for using food waste as a feedstock for food-grade ethanol.

### 2. Description of the Prior Art

The US Environmental Protection Agency (EPA) noted in 2015 that food is one of the largest components of the solid waste stream, comprising 21.1% of discarded solid waste. The US Department of Agriculture estimated in 2015 that 31 percent of food is lost (wasted) at the retail and consumer levels. Food waste in landfills degrades readily and creates methane, a potent greenhouse gas. Degradation of food waste contributes significantly to overall landfill methane emissions. The EPA noted in 2016 that only 5.1% of food waste is currently being diverted from disposal for composting or reuse. Accordingly, government regulators, the public, and industry want to prevent, reuse, or recycle food waste and otherwise remove it from the waste stream disposed in landfills or combusted in waste-to-energy plants.

The EPA established a goal to achieve a 50% reduction of food waste disposal by 2030. One objective of establishing this goal was to inspire new innovations and actions. To promote food waste reuse and recycling practices and to divert food waste from disposal, the EPA established a six-level food recovery hierarchy that, in order of preference, includes (1) source reduction, (2) feeding people, (3) feeding animals, (4) industrial uses, (5) composting, and (6) landfill and waste-to-energy processes.

Source reduction seeks to avoid creating food waste in the first place by targeted shopping, buying less food, and careful management of food inventories. Reducing food waste at its source saves energy associated with growing, preparing, and transporting food; saves money by buying only what is needed; avoids or reduces disposal costs; and saves labor costs through more efficient handling, preparation, and storage of food.

Feeding people in need can reduce the amount of uneaten food, such as the 38 million tons of food disposed in 2014. Healthy, unspoiled food can be donated to food banks, soup kitchens, food pantries, and shelters to help feed those in need.

Feeding animals is another approach to using food waste. Where practicable, edible food scraps can be used to feed animals at farms and zoos. Food waste may also be used to make pet food.

Industrial uses are another approach to use food waste. Food waste can be converted to biogas and soil amendment through anaerobic digestion processes. Fats, oils and grease can be processed for use as biofuels and rendering. Solid waste can be processed into industrial-grade ethanol and other chemicals through various processes as described below.

By composting, certain inedible portions of wasted food can be diverted to composting facilities. Composted food waste can be used as a soil amendment. Since composting takes place in the presence of oxygen, the breakdown of the organic material generates carbon dioxide, but does not generate methane, which is a much more potent greenhouse gas than carbon dioxide.

Disposing of food waste in landfills and waste-to-energy processes are the least desirable approach and are generally sought to be avoided.

Regulations are currently evolving to ban food waste from disposal in landfills. For example, Massachusetts has banned disposal of food waste in landfills since 2014. The ban applies to entities that generate more than one ton per week of food waste. Massachusetts has a goal of diverting 35% of food waste by 2020, or a total of 350,000 tons. To achieve this goal, more processing facilities are required, and end markets are needed for any high-value products produced. Connecticut, Rhode Island, Vermont, and California have enacted similar laws, and several more states are considering following suit. At the federal level, HR 4184, a bill titled The Food Recovery Act of 2015, has been proposed. This bill focuses on education, encouragement, and research associated with food waste diversion, but does not include a landfill ban on food waste.

Current approaches to using commercial and institutional food waste consist in part of composting, aerobic digestion, and waste processing to produce biogas and industrial-grade ethanol or other industrial feedstocks. Composting is more efficient and economical in rural farm areas where food waste generation is low, available land is abundant, and robust markets exist for the compost end product. Composting is less viable on a large scale in urban areas, where significant quantities of food waste must either be transported long distances to large processing facilities or processed locally at many dispersed locations each having a limited market for the resulting compost product.

Anaerobic digestion dedicated to convert food waste to biogas usually requires high capital and operating costs associated with constructing and running the digester. The costs for a digester dedicated to food waste are prohibitive compared to disposal costs in the United States and Canada.

Anaerobic digestion could be viable in rural areas where excess digestion capacity exists on farms that use this method to treat animal waste. Similarly, many larger municipalities use anaerobic digestion to treat municipal wastewater sludge from treatment plants, and these digesters may have excess capacity to treat processed food waste.

Anaerobic digestion of organic waste is common in Europe and is cost competitive with other disposal options. The European Union issued a Landfill Directive effective in 2001 that requires the biodegradable portion of solid waste to be reduced by 65 percent in 2016, and treatment of all but inert materials before landfilling. The costs to comply with the EU directive's waste handling and treatment requirements, the limited and costly landfill capacity, and the higher overall energy costs favor anaerobic digestion as a viable alternative for food waste in Europe.

Two processes in use in North America convert municipal solid waste, including food waste, into saleable end products such as industrial-grade ethanol. Both of these processes use a broader solid waste stream as a feed stock. For example, the Fiberight Company operates a solid waste treatment plant in Iowa City, Iowa that converts municipal solid waste to biogas (pipeline-quality methane/natural gas from organic waste) and industrial-specification ethanol. Fiberight is currently constructing another similar facility in Hampden, Me.

The Fiberight process accepts the entire waste stream. Initially, aluminum, ferrous metals, plastic, glass, mineral aggregates, and other recyclables are separated out of the waste stream and recycled using a process described in U.S. Pat. No. 7,745,208. The remaining waste, including food waste, is processed by a pulper at 160° to 180° F. in which soluble organics are separated from high-cellulose biomass pulp. Soluble organics are processed in an anaerobic digester to generate methane. Soluble organics are also processed into biogas, a mixture of mostly methane and carbon dioxide, or into pipeline-quality gas containing mostly methane. Insoluble organics derived from cellulose waste, cellulose fibers, and yard waste are subject to thermo-mechanical pre-treatment involving pH adjustment, heating to 260° F. for thirty minutes, and dewatering into a pulp press cake. The pulp cake is subjected to hydrolysis in the presence of enzymes to create a sugar solution. The sugar solution can be sold as an industrial feed stock, or converted to industrial-specification ethanol through fermentation and distillation.

In another example, the Enerkem Corporation is constructing a waste treatment plant in Edmonton, Canada. At this facility, recyclables and inert materials such as glass, sand, concrete, and ceramics are first removed from the waste stream. The remaining waste is processed in a steam gasification reactor at high pressures and heat of about 1400° F. to produce hydrogen and carbon monoxide as disclosed in U.S. Pat. No. 8,192,647. The gasses are subjected to catalytic synthesis to produce renewable biofuels and industrial chemicals such as ethanol and methanol.

The Enerkem Corporation also has an apparatus and a method for conversion of cellulosic material and household waste to ethanol and other products as disclosed in U.S. Pat. No. 8,123,864. The cellulosic material is subjected to continuous hydrothermal pre-treatment without the addition of chemicals, and a liquid and a fiber fraction are produced. The fiber fraction is subjected to enzymatic liquefaction and saccharification, ethanol fermentation, and recovery.

### SUMMARY OF THE INVENTION

Distilling vodka and other ethanol-based distilled beverages requires a feedstock of carbohydrates, typically some form of starch or sugar. A conventional distillery purchases a carbohydrate source, such as potatoes, delivers it from the farm to the distillery, mechanically breaks down the potatoes into a mash, heats the mash in the presence of enzymes to form sugars, adds yeast to turn the sugar into ethanol and create a beer, and distills the beer to separate the ethanol from the other components of the mash. Higher-quality vodkas are distilled many times and sometimes filtered or treated to remove excess water and off-flavor contaminants.

Running a distillery year-round requires a continuous source of fresh carbohydrates. In the case of potatoes, the distillery must sequentially buy the potatoes from farms operating in different seasonal growing zones and use expensive cold storage facilities for out-of-season sources.

Food waste has not been realized as a source of carbohydrates for food grade ethanol production. A drawback of the solid waste feedstock processes used in North America for industrial grade ethanol production is that they have yet to demonstrate cost parity with conventional landfill disposal. Also, since the facility accepts all solid waste, it has little control over the waste contents other than removing recyclables and materials such as plastic, metal, concrete, glass, and mineral aggregates. Further, these processes cannot be certified to produce food-grade ethanol because the contents of the feedstock are not fully known or knowable. The feedstock content likely contains some level of deleterious materials unfit for human consumption.

In the methods used both in Europe and North America, adding a new and separate waste stream to a facility that is designed for a different existing waste stream is a modification to the process that increases cost, complexity, and operational difficulty. Existing digesters to process food waste is limited to the excess capacity of the digester.

Other processes currently available also do not produce food-grade ethanol or distilled beverages using food waste as a carbohydrate source. By creating a consumer product from food waste, aspects of the present invention correspond to feeding people with food waste, the second-highest preference level in the EPA's hierarchy for reducing food waste.

Therefore, a need exists for systems and methods of producing food-grade ethanol and distilled beverages from a supply with a majority content from food waste. The present invention addresses this need by using food waste as a feedstock for food-grade ethanol and distilled beverages.

One aspect of the present invention is directed to a system for producing food-grade ethanol. In one embodiment, the system includes one or more suppliers or sources of food waste, where each source is, for example, a restaurant, a bakery, a grocery store, a commercial kitchen, a food vendor, or a commercial food products manufacturer. Collection bins are distributed to each source of food waste. Workers are trained to screen the food waste for unacceptable items. One or more vehicles are configured for collecting the collection bins containing the food waste from each source of food waste and delivering the bins to a distillery. The distillery is configured to process the collected food waste and convert the food waste to a flowable slurry for distillation.

In some embodiments of the system, the distillation facility has an agreement with each source of food waste that specifies the acceptable and unacceptable items in the food waste. In another embodiment of the system, each source of food waste and the distillation facility are located in an urban environment.

A second aspect of the present invention is directed to a method of producing food-grade ethanol from a feedstock of food waste, a distillery receiving collected food waste from the source(s), screening the collected food waste for unacceptable items, processing the hydrated food waste into a flowable slurry ready for distillation, and distilling the flowable slurry to food-grade ethanol. In optional subsequent steps, the food-grade ethanol is converted to vodka, gin, or other distilled beverage and ethanol is separated from a residual mash. Optionally, the residual mash is dewatered to result in waste solids.

A third aspect of the present invention is directed to a method of producing vodka from food waste. The method includes selecting one or more sources of food waste, providing one or more collection bins to each source of food waste, receiving collection bins containing collected food waste from the source(s), screening the collected food waste for unacceptable articles, processing the collected food waste into a flowable slurry, distilling the flowable slurry to a food-grade ethanol, and converting the ethanol to vodka by adding water and flavors as desired.

In some embodiments, the ethanol has a purity of at least 95%.

In some embodiments, each source is selected as a restaurant, a bakery, a grocery store, a commercial kitchen, a food vendor, or a commercial food products manufacturer. In some embodiments, a plurality of sources is selected, where each of the plurality of sources provides a different type or composition of food waste. In another embodiment, the method includes selecting the sources of food waste as a restaurant, a bakery, a grocery store, a commercial kitchen, a food vendor, or a commercial food products manufacturer. In some embodiments, the collected food waste comprises two or more food items selected from an uneaten prepared meal, a baked good, a cooked food, an expired food from a food vendor, a by-product from commercial food processing, and waste from commercial food preparation. In some embodiments, the collected food waste includes one or more food item prepared for human consumption and selected from pasta, rice, cooked potatoes, cooked corn, grains, bread, baked goods, sugar, sugar-based products, fruit, or fruit-based products.

In some embodiments, the collected food waste contains no more than 25% by weight of materials selected as raw corn, unprocessed grains, lignocellulose biomass, and raw potatoes. Lignocellulose biomass includes plant fibers, such as grass, wood, bark and the like.

In some embodiments, the collected food waste is not spoiled or otherwise harmful for human consumption. For example, the collected food waste is optionally refrigerated at the source to preserve freshness and avoid spoiling prior to collection.

In some embodiments, the method includes removing unacceptable articles from the collected food waste at the source and/or at the distillery. For example, plastic, metal, bone, shell, paper, wood, pebbles, and rubber are removed from the collected food waste. In some embodiments, animal products are removed from the food waste.

In some embodiments, the processing step includes hydrating the collected food waste, such as in a vessel. In other embodiments, the processing step includes chopping, cutting, macerating, or otherwise reducing the particle size of the food waste. In an optional step, an enzyme is added to the flowable slurry to convert starches to sugars. In some embodiments, the flowable slurry is heated to a temperature of about 150° F. together with the added enzyme.

In some embodiments, the distillery enters an agreement with each source of food waste to identify acceptable and unacceptable items. For example, workers at the source and/or at the distillery visually inspect the collected food waste and remove the unacceptable items. In some embodiments, non-fermentable items are removed. In other embodiments, plastic, glass, metal, paper, rubber, stone, and/or animal products are removed from the collected food waste.

### BRIEF DESCRIPTION OF THE DRAWINGS

FIG. 1 illustrates a system of the present invention for producing ethanol and distilled beverages from a feedstock of food waste.

FIG. 2 illustrates a flowchart with steps of one embodiment of a method of producing ethanol from food waste.

FIG. 3 illustrates a flowchart with steps of another embodiment of a method of producing vodka or other distilled beverages from food waste.

### DETAILED DESCRIPTION

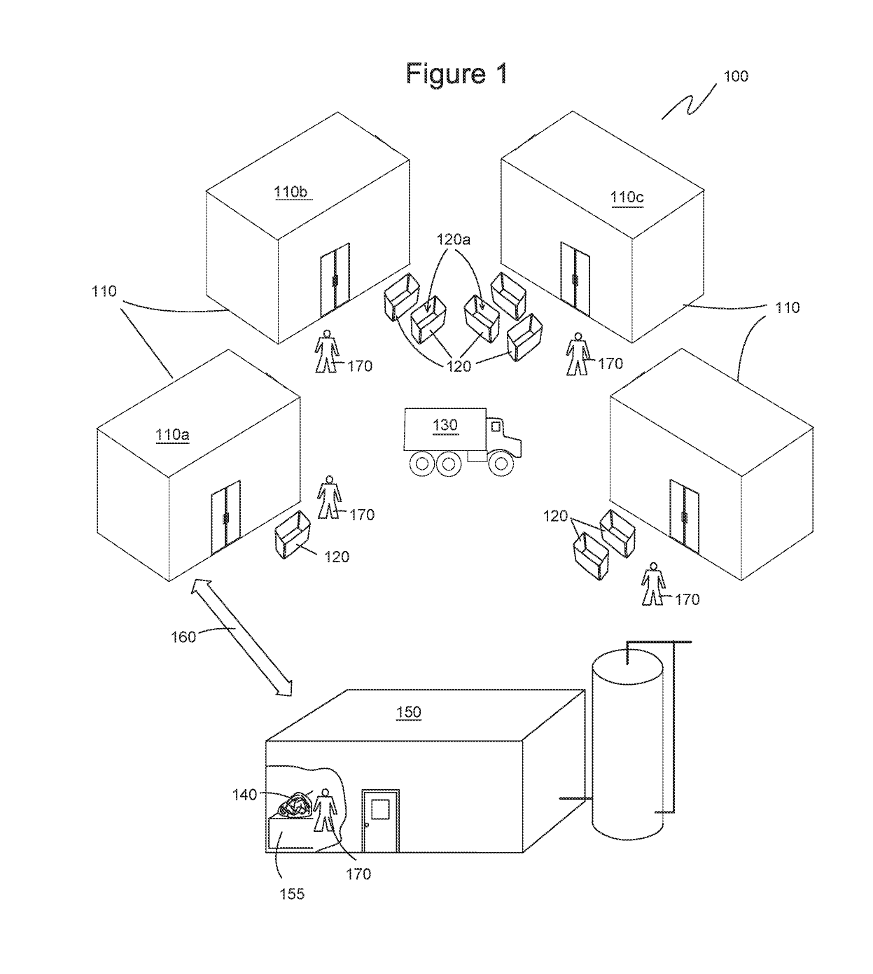

Exemplary embodiments of the present invention are illustrated in FIGS. 1-3. FIG. 1 illustrates one embodiment of a system 100 for producing food-grade ethanol and distilled beverages, such as vodka. System 100 includes one or more sources 110 of food waste 140. Each source 100 has one or more bins 120 or other container used to collect food waste 140 from each source 110. For example, bins 120 are distributed to each source 110 for collecting food waste 140. A vehicle 130 is configured to pick up bins 120 from each source 110 and deliver food waste 140 to a distillery 150. Distillery 150 is equipped to process food waste 140 and distill the processed food waste 140 to food-grade ethanol or distilled beverages, such as vodka, gin, or the like. Workers 170 look for and remove unacceptable items from food waste 140. In some embodiments, system 100 is sited in an urban location where a dense population generates food waste 140 in sufficient quantities to supply distillery 150 located in the same urban location. Accordingly, distillery 150 uses local food waste 140 in the production of food-grade ethanol and/or a high-value distilled beverage.

In embodiments of the present invention, food waste 140 is the primary carbohydrate source for making food-grade ethanol and distilled beverages, such as vodka. Food waste 140 is supplied by one or more sources 110, such as a restaurant, a grocery store, a bakery, a hotel, a food vendor, a wholesale produce terminal market, a cafeteria, a catering business, a resort, a hospital, a nursing home, a prison, a convention center, a convenience store, a sports venue, or other source 110 that provides prepared food to consumers.

For the purposes of this invention, food waste 140 includes prepared or raw food originally intended for consumption by a consumer, but now is to be disposed as waste or garbage. In some embodiments, food waste 140 is fresh, meaning that it has not spoiled or deteriorated to the extent that it is harmful for human consumption. Food waste 140 includes packaged food in a raw or cooked state intended for consumption by a consumer. Food waste 140 also includes meals prepared in a commercial kitchen. Accordingly, the food waste 140 may be uneaten or excess food that has been prepared for but not served to a consumer as well as plate scrapings and food scraps from meals served to a consumer but not eaten. Rather than dispose of uneaten food in the garbage, all or part of the uneaten food may be set aside as food waste 140 for producing ethanol according to the present invention. Food waste 140 also includes edible food that is otherwise unfit for sale, such as stale food, expired food, damaged food, non-conforming food products, and food beyond the sell-by date. Food waste 140 also includes bruised and blemished food or food otherwise rejected for sale or ingestion due to aesthetics. This includes, for example, bruised or damaged fruit and vegetables, damaged or mismarked packages of raw or cooked food, discolored food, and food removed from shelves when it does not sell within a specified time. Food waste further includes trimmings, waste, and by-products from commercial and industrial food preparation and food processing facilities.

Among other items, food waste 140 preferably includes foods rich in carbohydrates. Carbohydrates may include both sugars and starches (i.e., complex carbohydrates). Examples of foods rich in carbohydrates include pasta, rice, potatoes, corn, grains, bread and other baked goods, sugar and sugar-based products, and fruit and fruit-based products, tortillas, starchy vegetables and legumes. Other high-carbohydrate foods include sugary cereals, crackers, cakes, flours, jams, preserves, bread products, refined potato products, soft drinks, nuts, and yogurt. In some embodiments, the fruit and fruit-based products are post-consumer left overs, beyond their shelf life, bruised, or discarded during food preparation. In some embodiments, food waste 140 has a majority content from cooked foods, such as pasta, rice, bread, and other items prepared for consumption. Nonetheless, embodiments of the present invention permit some raw food and ingredients to be included in food waste 140, such as uncooked rice, uncooked pasta, uncooked fruits and vegetables, flour, grains, raw potatoes, and seeds. In some embodiments, the content of raw food does not exceed a predefined maximum amount, such as 10%, 25%, 40%, 50%, or 75% by weight or volume.

Control over food waste 140 from each source 110 is important for two reasons. First, when making premium-quality vodka or other distilled beverages, a consistent supply of food waste 140 is needed to develop a reproducible recipe. Second, distillery 150 needs to certify the ethanol as food-grade quality to obtain a federal distillery operating license. In addition to federal licenses to operate distillery 150, state licenses may be needed to accept, handle and process food waste 140. In some embodiments, system 100 is configured to also produce industrial-grade ethanol from food waste unfit for food-grade ethanol.

In some embodiments, each source 110 of food waste 140 is provided with one or more bins 110 so that food waste 140 is handled directly at the processing area of source 110 where it is generated. For example, bins 110 full of food waste 140 are replaced with clean bins 110 at the time of pickup. This procedure assures good sanitation and limits odors. Each source 110 of food waste 140 may prefer to use bins 110 sized appropriately for the volumes of food waste 140 and the pickup schedule. Similarly, larger bins 110 are used in one embodiment to accommodate a consolidated supply of food waste 140. Prompt, regular pickup of food waste 140 provides fresh food waste 140 to distillery 150 and reduces food spoilage and odors.

Control over food waste 140 is accomplished in one embodiment by implementing one or more quality-control measures, such as auditing the waste generation profile of potential sources 110, identifying the types of food waste 140 and the quantity generated by each source 110, entering an agreement 160 with source(s) 110 that specifies what food waste 140 is accepted and what food waste 140 or other waste is prohibited, instituting a training program for workers 170 at each source 110 and/or at the collection site 155 at the distillery 150, and providing appropriate supervision of workers 170. In some embodiments, bin contents 120a are inspected at the time of pickup from source 110 by observing the visible surface of bin contents 120a in bin 120. Bin contents 120a may additionally or alternately be visually inspected at distillery 150, for example, upon delivery or after bin 120 is emptied onto a tipping floor. Optionally, other detection and screening means are employed to identify and remove unacceptable items from food waste 140, such as sensors and metal detectors as used in the recycling industry.

In one embodiment, agreement 160 between distillery 150 and each source 110 establishes a protocol at source 110 so that food waste 140 acceptable for distillation is placed into one or more bins 110 provided by distillery 150. Bins 150 are collected frequently (e.g., daily) from source 110 and delivered to distillery 150 for further processing of bin contents 120a. In some embodiments, each source 110 refrigerates food waste 140 to prevent spoiling prior to bins 120 being collected.

In one embodiment, the protocol identifies food waste 140 suitable for distillation into ethanol and restricts bin contents 120a to certain items. For example, bin contents 120a must include at least 50% food waste 140 rich in carbohydrates, such as one or more items of bread and baked goods prepared from dough (e.g., rolls, bread, pizza crust, pies, pastries), raw or cooked pasta, cooked grains (e.g., rice, oats, cereal), cooked potatoes and potato products (e.g., French fries, mashed potatoes, hash browns). In some embodiments, bin contents 120a from the source(s) also include one or more raw items, such as raw grains, raw potatoes, fruit, and vegetables. These additional items may be in whole or processed form such as sliced, peeled, or otherwise modified from the natural form. In some embodiments, the acceptable bin contents 120a from source 110 are identified in agreement 160. As such, distillery 150 may control and tailor food waste 140 from any one or more sources 110 and the ratio of the types of food waste 140 received at distillery 150 to be processed for distillation.

In some embodiments, agreement 160 between distillery 150 and each source 110 of food waste 140 is selected to identify criteria for acceptable food waste 140 and unacceptable food waste 140 as applicable to each individual source 110, to a plurality of food sources 110, or to all currently-selected and prospective sources 110 of food waste 140. For example, each source 110 may be selected by distillery 150 to provide a predetermined type of food waste 140, where the aggrege of bin contents 120a received at distillery 150 from all selected sources 110 has the desired composition of food waste 140. Accordingly, bin contents 120a of any given source 110 may be only a portion of the total food waste 140 generated by that source 110.

In one embodiment, agreement 160 is selected to restrict animal products from food waste 140 disposed into bins 120, such as meats, fats, eggs, and dairy. In other embodiments, animal products or certain identified animal products are limited to pre-determined maximum content by weight or volume. For example, agreement 160 restricts the source(s) 110 from placing more than 15% by volume of animal products into bin(s) 120. In one embodiment, bin 120 may be partitioned for collecting various types of food waste 140 in desired proportions. In some embodiments where source 110 has a plurality of bins 120, each bin 120 may be designated for a predefined type of food waste 140. As such, a source's bin contents 120a are limited by the capacity of each bin 120. For example, one source 110 has four bins 120 with one of the bins 120 being designated for animal products only by color-coding, a label, by size, or other indicator. The remaining three bins 120 are designated for other food waste 140. Assuming bins 120 are all the same size in this example, bin contents 120a collected from source 110 will be about 25% animal products by volume when all bins 120 are filled to capacity.

In one embodiment, bin contents 120a from any single source 110 or from a plurality of sources 110 in the aggregate is at least 30%, at least 50%, at least 75%, at least 80%, or at least 90% by weight of food waste rich in carbohydrates. For example, one source 110a is a bakery whose food waste 140 is baked goods including croissants, muffins, scones, cakes, and breads, and the like; a second source 110b is a restaurant that provides plate scrapings, other uneaten prepared food, and ingredients to make the prepared food, such as pasta, bread, pizzas, rice, potatoes, and the like; and a third source 110c is a produce vendor whose food waste 140 includes unsellable fruit and produce in raw form, such as blemished and broken produce, overripe produce, and other unsold or unsellable produce. This exemplary group of food sources 110 provides an aggregate of bin contents 120a to distillery 150 that is rich in carbohydrates. Other selected sources 110 of food waste 140 are also acceptable and may depend on a disposal protocol established at source(s) 110 as well as sorting and screening methods employed at distillery 150 to achieve the desired types and quantities of food waste 140 for producing vodka or other distilled beverage.

In some embodiments, controlling bin contents 120a used to make vodka or other distilled beverage includes establishing a screening protocol at each source 110 of food waste 140. For example, the screening protocol includes training workers 170 at source 110 to dispose of pre-determined food waste 140 items in bin(s) 120 supplied by distillery 150 for collection. The screening protocol may include sorting food waste by type into corresponding bins 120 indicated for that type of food waste 140. The screening protocol may include removing unacceptable waste from food waste 140 prior to disposing in bin(s) 120. For example, the screening protocol calls for removing any non-food items from food waste 140, such as paper, metal, plastic, pebbles, rubber, bone, shell, wood, and toxins. The screening protocol may additionally call for removing or separating animal products from food waste 140. In some embodiments, the screening protocol includes a training program for all workers 170 who handle food waste 140, including, for example, table bussers, kitchen staff, cooks, and other members of the source's 110 team. In yet other embodiments, the screening protocol establishes one or more workers 170 to supervise, inspect, or audit the screening protocol and disposal practices at source 110. For example, an off-site supervisor visits each source periodically to inspect adherence to the screening protocol. In other embodiments, the supervisor is one of the workers at source 110 of food waste 140. In yet another embodiment, the supervisor is a worker 170 who collects bins 120 of food waste from each source 110.

Some embodiments of the present invention include the step of inspecting bin contents 120a collected from each source 110. In one embodiment, for example, the inspection step occurs by a worker 170 at distillery 150 after emptying each bin 120, for example, on a tipping floor or an open grate in the floor. Part of the inspecting step optionally includes removing unacceptable waste from bin contents 120a that may have been overlooked at source 110.

After bin contents 120a have been inspected and screened for unacceptable waste items, the screened food waste 140 is disposed into a vessel where it is hydrated as needed and processed into a slurry using chopper pumps, spinning blades, a hammer mill, a macerator, a disposal-type grinder, or other means to reduce particle size and produce a mash. When food waste 140 contains both sugars and starches, the sugars can be converted directly to ethanol by anaerobic yeast fermentation. The starches first need to be converted into sugar by heating the mash to about 150 degrees F. and adding amylase enzymes that catalyze the hydrolysis of starch into sugar. From this point forward, conventional vodka distillery techniques are followed to create the end product of food-grade ethanol, premium vodka, gin, or other distilled beverage.

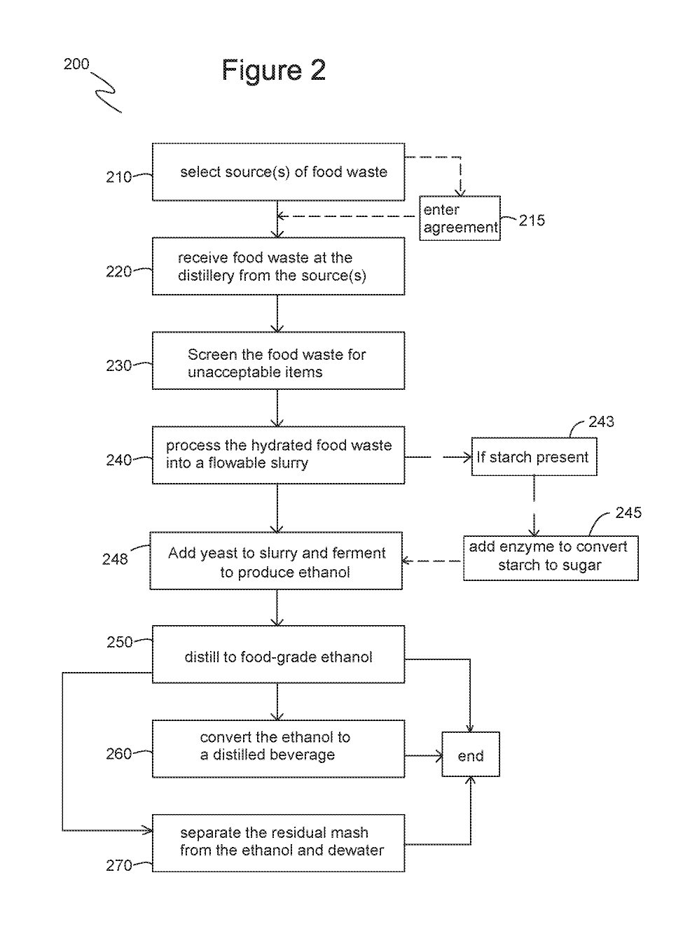

With continued reference to FIG. 1, aspects of system 100 discussed above apply to methods 200, 300 of producing food-grade ethanol and distilled beverages, respectively. FIG. 2 illustrates steps in an exemplary embodiment of a method 200 of producing food-grade ethanol. In step 210, one or more sources of food waste are selected. In one embodiment, each source 110 is a restaurant, a bakery, a grocery store, a commercial kitchen, a food vendor, or a commercial food products manufacturer. In some embodiments, each source 110 is selected at least in part based on being situated in an urban location with distillery 150.

In optional step 215, distillery 150 enters agreement 160 with each source of food waste to identify acceptable and unacceptable items. In some embodiments, agreement 160 establishes protocol at each source 110 for disposing, separating, screening, and/or storage of food waste 140.

In step 220, collected food waste 140 is received from source(s) 110. For example, vehicle 130 collects bins 120 containing food waste 140 from each source 110 and delivers bins 120 to distillery 150. In some embodiments, collected food waste 140 comprises two or more food items selected from an uneaten prepared meal, a baked good, a cooked food, an expired food from a food vendor, a by-product from commercial food processing, and waste from commercial food preparation.

In some embodiments, the collected food waste 140 contains no more than 25% by weight of materials selected as raw corn, unprocessed grains, lignocellulose biomass, and raw potatoes. Lignocellulose biomass includes plant fibers, such as grass, wood, bark and the like. In some embodiments, the collected food waste 140 includes one or more food items prepared for human consumption and selected from pasta, rice, cooked potatoes, cooked corn, grains, bread, baked goods, sugar, sugar-based products, fruit, or fruit-based products.

In step 230, the collected food waste 140 is screened for unacceptable items. For example, workers 170 at each source 110 and/or at distillery 150 visually inspects the collected food waste 140 and removes the unacceptable items. In some embodiments, non-fermentable items are removed. In other embodiments, plastic, glass, metal, paper, rubber, stone, and/or animal products are removed from the collected food waste 140.

In step 240, food waste 140 is processed into a flowable slurry ready for fermentation and followed by distillation. In some embodiments, step 240 includes hydrating food waste 140 in a vessel.

In optional step 243, a determination of whether the flowable slurry contains starches. If yes, the at optional step 245, an enzyme is added to the flowable slurry to convert starches to sugars. In some embodiments, step 245 includes heating the flowable slurry and enzymes to a temperature of about 150° F.

In step 248, the flowable slurry is fermented to produce ethanol.

In step 250, the flowable slurry is distilled to food-grade ethanol.

In step 260, the food-grade ethanol is converted to vodka, gin, or other distilled beverage.

In optional step 270, ethanol is separated from a residual mash and the residual mash is dewatered to result in waste solids.

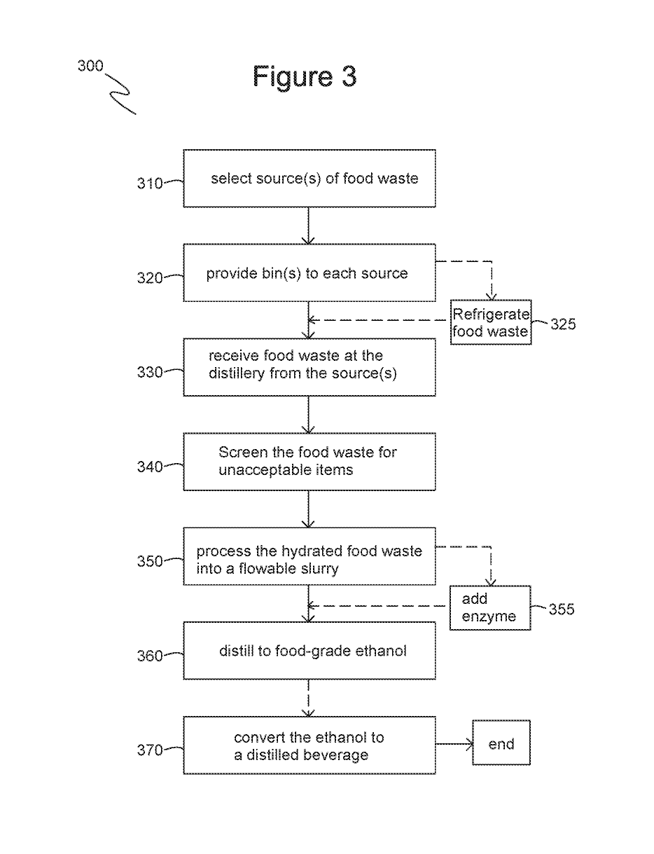

Referring now to FIG. 3, a flow chart illustrates steps in an exemplary method 300 of producing vodka from food waste. In step 310, one or more sources 110 of food waste 140 are selected. In some embodiments, each source is a restaurant, a bakery, a grocery store, a commercial kitchen, a food vendor, or a commercial food products manufacturer. In some embodiments, a plurality of sources 110 are selected, where each of the plurality of sources provides a different type or composition of food waste. Other selection criteria may apply as discussed herein.

In step 320, one or more collection bins 120 are provided to each source 110 of food waste 140.

In optional step 325, the collected food waste is refrigerated at source 110 to preserve freshness and to avoid spoiling.

In step 330, collection bins 120 containing collected food waste are received from source(s) 110. In some embodiments, the collected food waste 140 is not spoiled or otherwise harmful for human consumption.

In step 340, the collected food waste 140 is screened for unacceptable articles. In some embodiments, step 320 includes removing the unacceptable articles from the collected food waste at each source 110 and/or at distillery 150. For example, plastic, metal, bone, shell, paper, wood, pebbles, and rubber are removed from the collected food waste 140. In some embodiments, animal products are removed from food waste 140.

In step 350, the collected food waste 140 is processed into a flowable slurry. In some embodiments, step 325 includes hydrating the collected food waste 140. In other embodiments, step 325 includes chopping, cutting, macerating, or otherwise reducing the particle size of food waste 140.

In optional step 355, an enzyme is added to the flowable slurry to convert starches to sugars. In some embodiments, step 327 includes heating the flowable slurry to a temperature of about 150° F.

In step 360, the flowable slurry is distilled to a food-grade ethanol.

In step 370, the food-grade ethanol is converted to vodka or other distilled beverage. The ethanol is used to produce vodka by diluting with water. Flavored vodkas are created by further addition of fruit, spices, herbs, coffee, tea, chocolate, dairy and other flavorings. Gin is created by the addition of juniper berries or juniper flavoring during or after distillation.

In some embodiments of the present invention, the distilling process produces a food-grade ethanol with a purity of about 95%.

The distillation process produces a residual waste mash after the ethanol is removed. The mash is dewatered using a filter press, with the waste water disposed in the sanitary sewer or used as a fertilizer. Solids from the filter press optionally are used as animal bedding, an amendment to soil composting operations, or combusted as fuel for the distilling process.

The use of fresh food waste 140 and locating the handling, processing, and distillation of the food waste in an enclosed building reduces the release of odors to the surrounding environment. Ventilation with activated carbon filters optionally are used to mitigate odors emanating from distillery 150. Locating distillery 150 in a dense urban area reduces food waste 140 collection costs since sources 110 of food waste 140 are preferably selected based on proximity to distillery 150 as one criterion.

Conventional waste collection and disposal in large urban areas involves transferring and consolidating the waste into larger containers, and long hauls, up to hundreds of miles or more, to a disposal or treatment facility. In contrast, embodiments of the present invention identify sources 110, collect, and process food waste 140 locally to lower trucking costs, reduce fuel usage, reduce emissions, and reduce truck traffic. Local handling of food waste 140 therefore provides a significant economic advantage over conventional waste disposal. Similarly, distillery 150 using a feedstock of food waste 140 may be paid waste disposal fees by each source 110 to accept food waste 140, further providing an economic advantage over conventional distilleries that purchase carbohydrate feedstock such as potatoes from farms.

According to embodiments of the present invention, distillery 150 is advantageously positioned to attract the business of local residents and sources 110 of food waste 140. The present invention encourages area residents to buy their local neighborhood vodka. Grocery stores and restaurants are enticed to advertise their participation in food waste 140 program and to sell the vodka at their business. By avoiding conventional liquor distribution channels in favor of sales to local residents and businesses, the present invention has low distribution costs for at least some of the products of the distillery.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

We claim:

1. A method of producing food-grade ethanol from food waste, the method comprising:
selecting one or more sources of food waste, each of the one or more sources selected from the group consisting of a restaurant, a bakery, a grocery store, a commercial kitchen, a food vendor, and a commercial food products manufacturer;
receiving collected food waste from the one or more sources;
removing non-fermentable items from the collected food waste forming a fermentable food waste;
processing the fermentable food waste into a flowable slurry;
fermenting the flowable slurry into a mixture of ethanol and a residual mash; and
distilling the ethanol into food-grade ethanol.

2. The method of claim 1, wherein the collected food waste comprises two or more food items selected from the group consisting of an uneaten prepared meal, a baked good, cooked food, expired food from a food vendor, a by-product from commercial food processing, and waste from commercial food preparation.

3. The method of claim 1 wherein the step of fermenting includes:
adding a quantity of amylase enzyme to the flowable slurry; and
heating the slurry to about 150° Fahrenheit, thereby converting starch into sugar.

4. The method of claim 1 further comprising:
separating the ethanol from a residual mash; and
dewatering the residual mash forming waste solids.

5. The method of claim 1 further comprising:
providing to the one or more sources of food waste a list of acceptable food waste and unacceptable food waste.

6. The method of claim 5, further comprising screening the collected food waste for unacceptable waste.

7. The method of claim 1, wherein the removing step includes removing the non-fermentable items selected from the group consisting of plastic, glass, metal, paper, rubber, stone, and animal products.

8. The method of claim 1, wherein the receiving step includes receiving collected food waste containing no more than 25% by weight of materials selected from the group consisting of raw corn, unprocessed grains, lignocellulose biomass, and raw potatoes.

9. The method of claim 1, wherein the receiving step includes receiving collected food waste having one or more food items prepared for human consumption and selected from the group consisting of pasta, rice, cooked potatoes, cooked corn, grains, bread, baked goods, sugar, sugar-based products, fruit, and fruit-based products.

10. A system for producing vodka from food waste, the system comprising:
one or more suppliers of food waste, each of the one or more suppliers selected from the group consisting of a restaurant, a bakery, a grocery store, a commercial kitchen, a food vendor, and a commercial food products manufacturer;
collection bins distributed among each of the one or more suppliers of the food waste wherein the food waste is placed within the collection bins;
one or more vehicles configured for collecting the collection bins containing the food waste from each of the one or more suppliers of food waste;
a distillery having (1) a processing area to receive the collection bins containing the collected food waste and (2) processing equipment configured to convert the food waste to a flowable slurry for fermentation and distillation forming food-grade ethanol whereby the food-grade ethanol is processed into vodka.

11. The system of claim 10, further comprising one or more screening personnel at the one or more suppliers of food waste, at the distillery, or at both wherein the one or more screening personnel look for and remove unacceptable items from the food waste.

12. The system of claim 11, further comprising a list of acceptable and unacceptable items used by the one or more screening personnel.

13. The system of claim 10, wherein each of the one or more sources of food waste and the distillery are located in an urban environment.

14. A method of producing vodka from food waste comprising:
selecting one or more sources of food waste, each of the one or more sources selected from the group consisting of a restaurant, a bakery, a grocery store, a commercial kitchen, a food vendor, and a commercial food products manufacturer;
providing one or more collection bins to each of the one or more sources of food waste;
collecting the one or more collection bins containing collected food waste;
screening the collected food waste for unacceptable articles;
removing the unacceptable articles from the collected food waste;
processing the collected food waste into a flowable slurry;
fermenting the flowable slurry into ethanol and residual mash;
distilling the ethanol to a food-grade ethanol; and
converting the food-grade ethanol to vodka.

15. The method of claim 14, wherein the processing step includes hydrating the collected food waste.

16. The method of claim 14, wherein the step of screening the collected food waste for unacceptable articles includes removing articles selected from the group consisting of plastic, metal, bone, shell, paper, wood, and rubber.

17. The method of claim 16, wherein the step of screening the collected food waste for unacceptable articles further includes removing animal products from the food waste.

18. The method of claim 14, wherein the collected food waste is not harmful for human consumption.

19. The method of claim 14 further comprising:
adding an enzyme to the flowable slurry; and
heating the flowable slurry to convert starch to sugar.

20. The method of claim 14 further comprising refrigerating the collected food waste prior to the step of collecting the one or more collection bins.
